(19) United States
(12) Patent Application Publication
(10) Pub. No.: US 2011/0115875 A1
(43) Pub. Date: May 19, 2011

(54) Assisted Communication System

(75) Inventors: Laurence P. Sadwick, Salt Lake City, UT (US); Ruey-Jen Hwu, Salt Lake City, UT (US); Aaron Sadwick, Salt Lake City, UT (US)

(73) Assignee: InnoVate, LLC

(21) Appl. No.: 12/775,472

(22) Filed: May 7, 2010

Related U.S. Application Data
(60) Provisional application No. 61/176,453, filed on May 7, 2009.

(51) Int. Cl. H04N 7/14

(52) U.S. Cl. 348/14.08; 348/E07.077

(57) ABSTRACT

Various embodiments of an assisted communication system are disclosed herein. In one embodiment, an assisted communication system includes a computer, display, camera, microphone, network connection, and a controller connected to the computer, the camera, the microphone, and the network connection. The controller is adapted to receive commands over the network connection to initiate video conferences on the computer using the camera and the microphone. The controller is also adapted to receive commands over the network connection to select and initiate entertainment programming such as television programs, movies and music on the display.

### CROSS REFERENCE TO RELATED APPLICATIONS

The present application claims priority to U.S. patent application Ser. No. 61/176,453 entitled “Assisted Communication System”, filed May 7, 2009, the entirety of which is incorporated herein by reference for all purposes.

### BACKGROUND

Electronic device can be difficult to configure and operate, including devices that enable communications such as telephones, computers, televisions, etc. This is particularly true for persons with disabilities, such as those with limited mobility and/or mental faculties and those in health care facilities or nursing homes, etc. For example, it may be difficult for a person with limited mobility to reach and dial a telephone, to control a television, to use a computer or other video or audio teleconferencing equipment, etc.

### SUMMARY

The present invention provides an assisted communication system enabling a user to remotely configure, set up and operate electronic devices such as telephones, computers, audio/visual equipment, environmental monitoring equipment, and health care monitoring equipment.

In one embodiment, an assisted communication system includes a computer, display, camera, microphone, network connection, and a controller connected to the computer, the camera, the microphone, and the network connection. The controller is adapted to receive commands over the network connection to initiate video conferences on the computer using the camera and the microphone. The controller is also adapted to receive commands over the network connection to select and initiate entertainment programming such as television programs, movies and music on the display.

In an embodiment of the assisted communication system, the controller is adapted to synchronize playback of the entertainment programming on the display with remote playback of the entertainment programming at another location and to initiate an audio conference during the entertainment programming with the other location using the microphone.

An embodiment of the assisted communication system also includes a voice activated interface connected to the controller.

In an embodiment of the assisted communication system, the voice activated interface includes multiple language support.

In an embodiment of the assisted communication system, the controller is adapted to receive commands over the network connection to activate the camera and microphone for remote monitoring.

In an embodiment of the assisted communication system, the controller is adapted to have a privacy mode that can be initiated at the computer.

In an embodiment of the assisted communication system, the controller is adapted to receive commands over the network connection to remotely control the computer.

In an embodiment of the assisted communication system, the network connection may include Ethernet, cellular, telephone land line, WiFi, Zigbee, Bluetooth, voice over internet protocol, IEEE wired and wireless communication standards, proprietary communication systems, etc., and/or local area network.

An embodiment of the assisted communication system also includes sensors such as a temperature sensor, light sensor, humidity sensor, and vibration sensor.

An embodiment of the assisted communication system also includes a speaker.

In an embodiment of the assisted communication system, the controller includes a lighting controller.

In an embodiment of the assisted communication system, the controller includes a temperature controller.

In an embodiment of the assisted communication system, the computer is a ruggedized water-resistant touch screen portable computer.

An embodiment of the assisted communication system also includes a telephone connected to the controller, wherein the controller is adapted to control the telephone to initiate and answer calls and to activate a speakerphone function on the telephone.

In an embodiment of the assisted communication system, the controller is connected to a health care provider communication system and is adapted to initiate calls to the health care provider communication system in response to commands over the network connection.

In an embodiment of the assisted communication system, the controller is adapted to trigger a nurse paging system in response to commands over the network connection.

An embodiment of the assisted communication system also includes an interface to patient monitoring equipment, and the controller is adapted to display patient diagnosis information on the display and to transmit it over the network connection.

In an embodiment of the assisted communication system, the controller is adapted to initiate an emergency call when the patient diagnosis information indicates an emergency.

In an embodiment of the assisted communication system, the display is a touch screen display, and the controller is adapted to present a user interface on the display enabling a patient to initiate a telephone call and a video conference with single touches on the display.

In an embodiment of the assisted communication system, the controller is adapted to receive service requests including food requests from an input device and to transmit the service requests to a support staff information system.

This summary provides only a general outline of some particular embodiments. Many other objects, features, advantages and other embodiments will become more fully apparent from the following detailed description. Nothing in this document should be viewed as or considered to be limiting in any way or form.

### BRIEF DESCRIPTION OF THE DRAWINGS

A further understanding of the various exemplary embodiments may be realized by reference to the figures which are described in remaining portions of the specification. In the figures, like reference numerals may be used throughout several drawings to refer to similar components.

FIG. 1 depicts a block diagram of an assisted communication system.

FIG. 2 depicts a block diagram of a controller that may be used in an assisted communication system.

FIG. 3 depicts an example of a display layout that may be used in one operating mode of an assisted communication system.

FIG. 4 depicts a block diagram of example elements of an assisted communication system that may be included in various embodiments of an assisted communication system.

### DESCRIPTION

An assisted communication system is disclosed herein that enables a user to assist another person or persons to use various electronic devices such as communications, computing, entertainment, monitoring and control devices. For example, the assisted communication system may be used by persons in health care facilities when they have limited mobility or other faculties. A remote user can use the assisted communication system to initiate telephone calls, control computers, televisions or other audio/visual and/or entertainment equipment, monitoring devices, nurse summoning devices, etc. The assisted communication system may assist the local user to more easily operate devices in the system, for example by providing a telephone with relatively large pictures of family or friends to automatically dial the pictured person's telephone number.

Features that may be included in various embodiments of the assisted communication system are set forth below. The assisted communication system is not required to include all of these features, and may be customized as desired.
Can use web based communications, cell phone, land line, telephone, cable, two-way radio, etc.
Allows interactive, interactions, multi-user, multi-participants
Can be remotely turned on, can monitor, alert, etc.
Can support a variety of diverse hardware
Can be made ultra simple with only a few (or even one) “button” to push
Can be voice activated/controlled
Can be notified/provide notification by various events: i.e., pushing a button, voice, time, etc
Can send notifications by e-mail, text message, phone call, web alert, etc. and can set the priority/urgency
Can make autonomous decisions regarding dangerous or emergency systems
Can be extremely portable
Can make use of one or more cameras per location including motorized cameras, web-based cameras, fixed position cameras, multiple cameras, wireless cameras, etc. computer mounted cameras, etc.
Can be mounted on people including on the forehead
Can support numerous types of diverse sensors with many/most available in wireless models
Can be portable and highly relocated
Can be designed as a cell phone based system including the cell phone
Can provide security including security and anti-theft measure for the system itself
Allows all types of interactive games and physical/mental interactions including simple board games, advanced games, picture sharing, movie watching with others at the same
   time, hand-eye coordination development/enhancement, computer enhanced/supported physical therapy, etc
Can provide personalized services
Allows numerous inputs including sensors, analog, digital, transducers, medical inputs
Can have a variety of outputs including controlling ones
Can have recording/playback features
Can have modesty/blanking with override/interrupt etc
Can be set to various levels of event triggering
Can have a number of nearby cameras that can be shared with others in common/public areas (e.g., dining room, patios, exercise areas, bingo, card playing areas, movie area, physical therapy areas, etc
Can be tailored to individual's needs and capabilities
Can work with all types of TVs including standard and HDTVs, computer monitors, etc
Can be simple to ultra sophisticated (Cadillac) versions, systems, and models
Can have cell phone, web, computer, pager, pop-ups, etc. to alert family etc
Can contact staff if needed
Patient can use system to request special outside services (including food, supplies, etc)
Can have nurse or doctor conferences with family members who may be anywhere in the world and in a number of different locations
Can have multiple users/visitors on the system concurrently
Can have multiple users/visitors interacting on the system concurrently

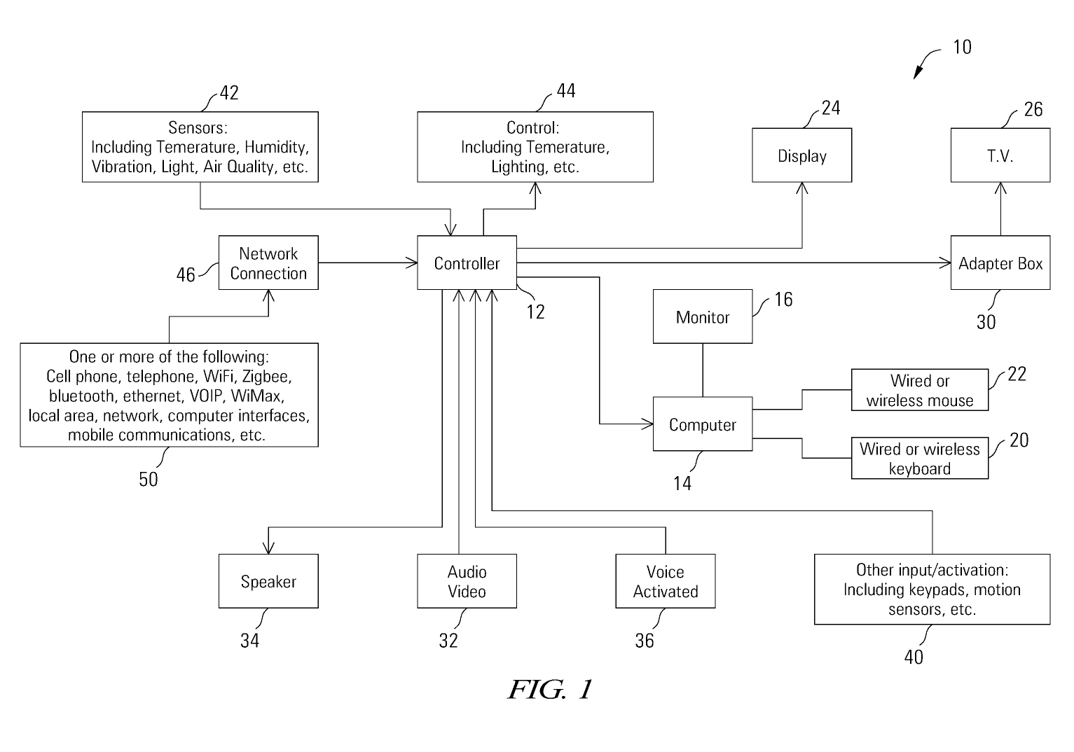

A block diagram of one embodiment of an assisted communication system 10 is illustrated in FIG. 1. A controller 12 is provided to interact with and control other devices in the system 10, such as a computer 14. The computer 14 may include a monitor 16 and input devices such as a wired or wireless keyboard 20 and mouse 22. The monitor 16 may be adapted for ease of use and placement in a care facility environment, such as a flat touch screen display that is water resistant and easily cleanable. The assisted communication system 10 may include other displays 24 as desired to display system status, provide a user interface, or to display entertainment programming or other content as desired. The assisted communication system 10 may also be adapted to connect to a television 26, using an adapter 30 as needed, to control the television 26 by turning it on and off, changing channels and volume, scheduling events, and streaming information or content to be displayed on the television 26. A media library 32 may be included and connected to the controller 12 for display on the monitor 16, display 24, television 26, or on a speaker 34.

The assisted communication system 10 may include a voice recognition system 36 to enable voice control of some or all of the features of the system 10, with customizable language support. Other user input devices 40 may be included as desired, such as keypads, motion sensors, etc., to simplify control of the system for patients. Sensors 42 may be included to provide information about the environment to the patent, caregivers and remote users. For example, light sensors, temperature sensors, humidity, vibration and air quality sensors may be included as desired, either to report the information or to enable the controller 12 to change the environment based on the information. For example, lighting and temperature controllers 44 may be included in the assisted communication system 10 so that the controller 12 can be used to turn on and off lights, dim lights, adjust the room temperature, etc., either automatically or under manual control. Turn on, turn off, dimming, and other types of control and monitoring can also be done remotely provided that the remote user/visitor has appropriate permission and access to do so.

The assisted communication system 10 includes a network connection 46 allowing remote connections through one or more connection mechanisms 50, including for example cellular, land line telephone, Ethernet, WiFi, Zigbee, Bluetooth, voice over internet protocol (VOIP), local area network (LAN), etc. The controller 12 can thus receive commands and information requests and otherwise communicate with remote users to access and control the system 10, so that a remote user can assist a patient with controlling various parts of the system 10 and can initiate communication with the patient.

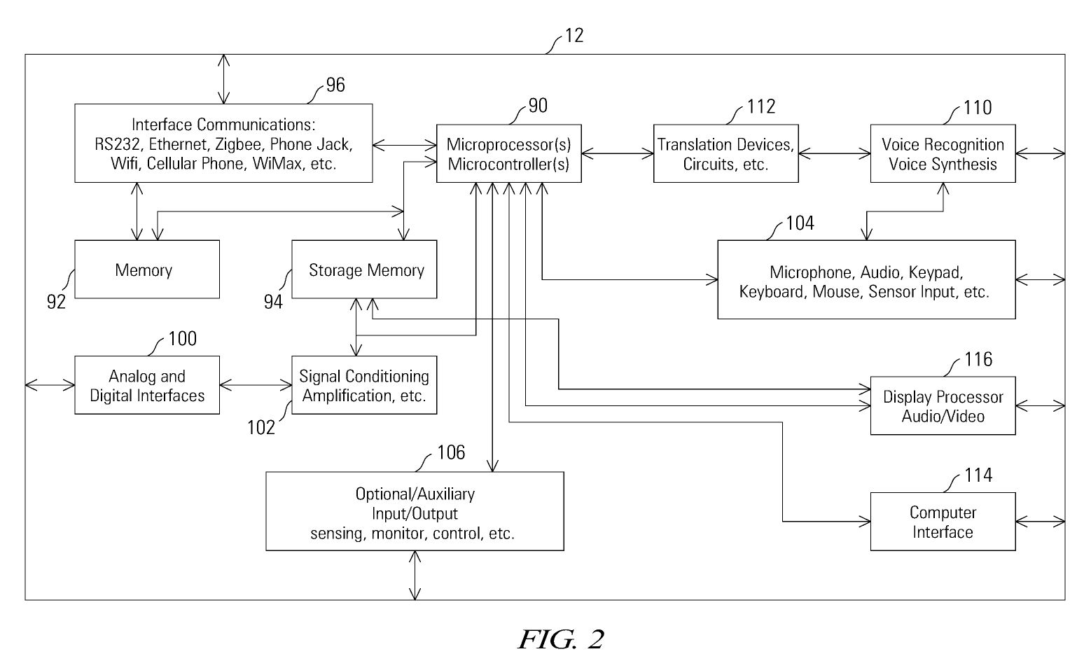

Details of the controller 12 are illustrated in the block diagram of FIG. 2. One or more microprocessors and/or microcontrollers 90 are included and are connected to one or more memory devices 92 and 94, whether volatile or non-volatile or a mix thereof. In other embodiments, the microprocessors and/or microcontrollers 90 are replaced with other suitable control devices, such as state machines, digital logic, analog and digital logic, application specific integrated circuits (ASICs), gate arrays, configurable logic devices (CLDs), etc. A number of interface devices are included, such as a network interface 96, analog and digital interfaces 100 for a variety of input devices and sensors, etc, along with signal conditioning and processing devices 102 as needed. A user input interface 104 allows input from keyboard, mouse, touch screen, microphone, video camera, audio input for music or other uses, and other sensors. A sensor interface 106 processes input from devices such as environmental sensors, light sensors, temperature sensors, etc as well as sensor-based user input devices. The controller 12 may also include an onboard voice recognition system 110 and translation systems 112 as desired to enable voice control of the system 10, data entry, remote communication, etc. The controller 12 may also include a computer interface 114 and a display processor 116 for connection to a computer 14, television 26, and other devices.

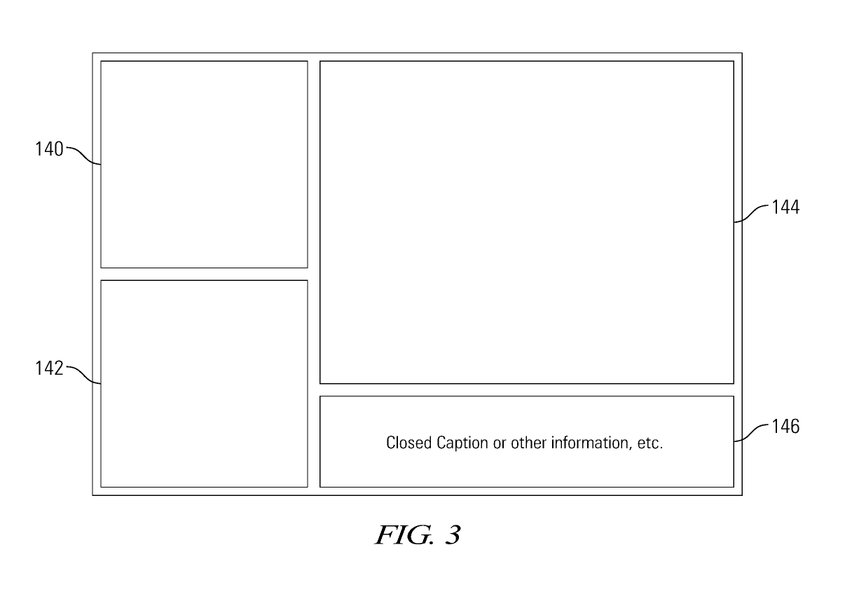

A user interface and content may be shown on one or more displays (e.g., 16, 24 or 26) and may be adapted to show a single source of information, such as a television program, a web conference video stream, a computer interface such as a web processor, etc., or may be divided into multiple information panels 140, 142, 144 and 146 as illustrated in FIG. 3. For example, a movie may be played on a main panel 144 with closed captioning in another panel 146, while a web conference video stream is played on another panel 140 and vital signs such as pulse rate, blood pressure and blood oxygen level are displayed on yet another 142. Information may be organized on the display (e.g., 16, 24 or 26) in a static predetermined manner, or may be adjusted as desired by the patient or remote visitors. The assisted communication system 10 may be adapted to display any information desired, such as medication reminders, etc.

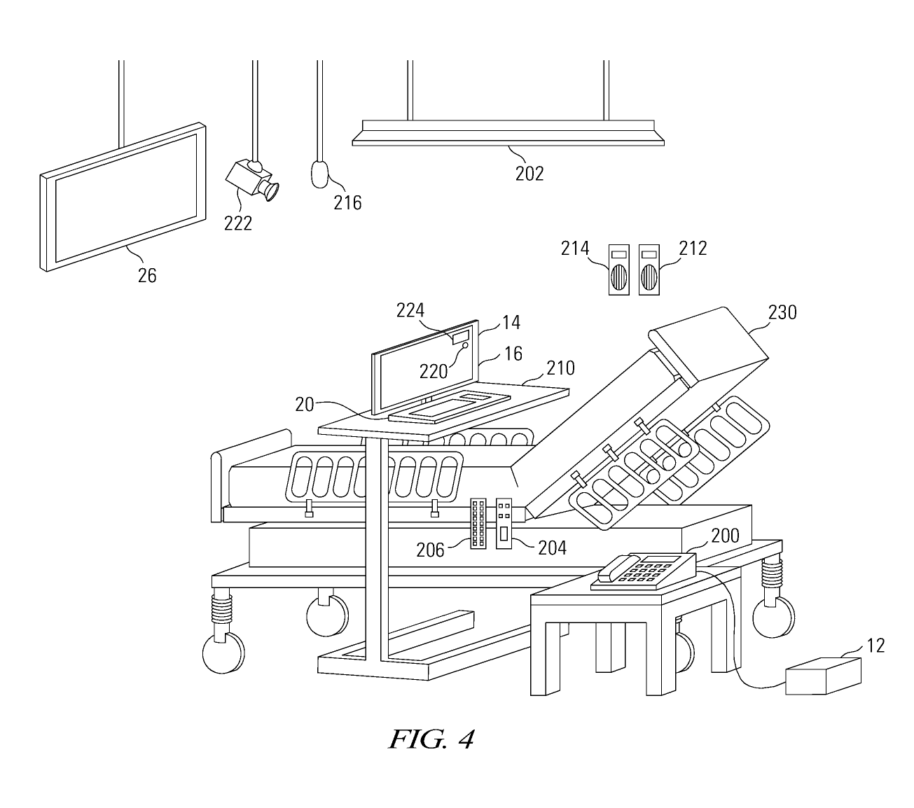

A diagram of the assisted communication system 10 as it may be used in a health care facility room or other location is illustrated in FIG. 4. The controller 12 may be located in any convenient location and may include wired and wireless connections to other components of the assisted communication system 10, such as a wired connection to a telephone 200 and a wireless connection to a computer/monitor 14 and 16. As described above, the controller 12 may be used to control lighting 202, television 26, computer 14, etc. The controller 12 may interface with existing types of controls to issue commands and to retrieve status, including nurse call buttons 204 and entertainment system remote controls 206. The computer 14 and monitor 16 may be adapted to be placed on a multi-use moveable tray 210 and removed if desired to allow other uses of the tray 210. The controller 12 may be adapted to read sensors such as in a thermostat 212 and to control the thermostat 212 and lighting controls 214. Microphones 216 and 220 and cameras 222 and 224 may be placed and arranged in various manners and connected to and controlled by the controller 12, whether by wired or wireless connections. Adjustable beds 230 may also be controlled via the controller 12. All devices connected to the controller 12 may be operated by local control using input devices such as a keyboard 20, voice command, or other inputs, or may be operated remotely by a remote user accessing the system 10 through the controller 12 to assist the patient. For example, the remote user may be able to access the controller 12 through a secure network connection and initiate video or audio calls, turn on television programs, movies or music, display pictures, dim lights, change the temperature of the room, communicate with nurses or other staff in a health care facility, etc. Certain features, controls, monitoring, etc. may be disabled or limited at certain or particular times or events or under certain circumstances as, for example, deemed necessary, desired or required. Protection and limitations may be included in the system both from physical and mechanical standpoints and an electrical and software standpoints including analog and digital methods, implementations and ways and means.

The controller 12 may also be adapted to enable the remote user to turn on the microphone (e.g., 216) and/or camera (e.g., 222) to monitor the care being given the patient. The controller 12 may be provided with a privacy mode to disable remote monitoring. The privacy mode can be activated by a number of means and methods including by the primary user, remote user and others. Certain privacy modes can respond to and be activated by, as examples, passwords, keywords, written words, spoken words, mechanical means such as pushing a button or activating a sensor or switch, etc.

The controller 12 may be contained in a single device, or the functions and components described herein may be distributed in multiple devices and locations. The assisted communication system 10 enables a patient with limited mobility or other restrictions to easily access and control all of the devices and services available in their environment and to interact with others remotely. The assisted communication system 10 also enables a remote user to perform this same access and control to remotely aid a patient and to communicate with the patient. For example, the controller 12 may be configured to synchronize playback of entertainment programming such as a movie on a display 26 and to synchronize it with playback of the same entertainment programming at another location while an audio or video conference is held, allowing the patient and loved ones to enjoy the programming together and to communicate during the playback.

The assisted communication system 10 enables someone with limited mobility or other restrictions to control their environment, to receive aid from remote users, to communicate with others and for their status to be monitored as needed. The assisted communication system 10 can greatly enhance the safety, care and comfort of a person needing additional help, whether in a health care facility such as a nursing home or in their own home.

While illustrative embodiments have been described in detail herein, it is to be understood that the concepts disclosed herein may be otherwise variously embodied and employed.

What is claimed is:

1. An assisted communication system, comprising:
a computer;
a display;
a camera;
a microphone;
a network connection; and
a controller connected to the computer, the camera, the microphone, and the network connection, the controller being adapted to receive commands over the network connection to initiate video conferences on the computer using the camera and the microphone, the controller further being adapted to receive commands over the network connection to select and initiate entertainment programming on the display, the entertainment programming comprising television programs, movies and music.

2. The assisted communication system of claim 1, wherein the controller is adapted to synchronize playback of the entertainment programming on the display with remote playback of the entertainment programming at another location and to initiate an audio conference during the entertainment programming with the other location using the microphone.

3. The assisted communication system of claim 1, further comprising a voice activated interface connected to the controller.

4. The assisted communication system of claim 3, wherein the voice activated interface includes multiple language support.

5. The assisted communication system of claim 1, wherein the controller is adapted to receive commands over the network connection to activate the camera and microphone for remote monitoring.

6. The assisted communication system of claim 1, wherein the controller is adapted to have a privacy mode that can be initiated at the computer.

7. The assisted communication system of claim 1, wherein the controller is adapted to receive commands over the network connection to remotely control the computer.

8. The assisted communication system of claim 1, wherein the network connection comprises at least one element selected from the group consisting of Ethernet, cellular, telephone land line, WiFi, Zigbee, Bluetooth, voice over internet protocol, and local area network.

9. The assisted communication system of claim 1, further comprising at least one sensor selected from the group consisting of a temperature sensor, light sensor, humidity sensor, and vibration sensor.

10. The assisted communication system of claim 1, further comprising a speaker.

11. The assisted communication system of claim 1, wherein the controller comprises a lighting controller.

12. The assisted communication system of claim 1, wherein the controller comprises a temperature controller.

13. The assisted communication system of claim 1, wherein the computer comprises a ruggedized water-resistant touch screen portable computer.

14. The assisted communication system of claim 1, further comprising a telephone connected to the controller, wherein the controller is adapted to control the telephone to initiate and answer calls and to activate a speakerphone function on the telephone.

15. The assisted communication system of claim 1, wherein the controller is connected to a health care provider communication system and is adapted to initiate calls to the health care provider communication system in response to commands over the network connection.

16. The assisted communication system of claim 15, wherein the controller is adapted to trigger a nurse paging system in response to commands over the network connection.

17. The assisted communication system of claim 1, further comprising an interface to patient monitoring equipment, wherein the controller is adapted to display patient diagnosis information on the display and to transmit it over the network connection.

18. The assisted communication system of claim 17, wherein the controller is adapted to initiate an emergency call when the patient diagnosis information indicates an emergency.

19. The assisted communication system of claim 1, wherein the display comprises a touch screen display, and wherein the controller is adapted to present a user interface on the display enabling a patient to initiate a telephone call and a video conference with single touches on the display.

20. The assisted communication system of claim 1, wherein the controller is adapted to receive service requests including food requests from an input device and to transmit the service requests to a support staff information system.
